(19) United States
(12) Patent Application Publication
(10) Pub. No.: US 2012/0119999 A1
(43) Pub. Date: May 17, 2012

(54) Adaptive Keyboard for portable device

(76) Inventor: Scott C. Harris, Rancho Santa Fe, CA (US)

(21) Appl. No.: 13/292,441

(22) Filed: Nov. 9, 2011

Related U.S. Application Data
(60) Provisional application No. 61/412,613, filed on Nov. 11, 2010.

(51) Int. Cl. G06F 3/02

(52) U.S. Cl. 345/169

(57) ABSTRACT

An adaptive keyboard on a touch screen device. The keyboard can reuse key areas, can detect positions of fingers, and can make it in general easier for users to type.

This application claims priority from provisional application No. 61/412,613, filed Nov. 11, 2010, the entire contents of which are herewith incorporated by reference.

### BACKGROUND

Various kinds of portable computers minimize the space by accepting their data entry using a touchscreen or other device that allows entry on the screen of the computer. For example, the popular iPad tablet produces a touchscreen that allows entering data.

The touchscreen can also display a keyboard that is used to type into the computer itself or into a program running in the computer.

### SUMMARY

The present application teaches a special kind of adaptive keyboard for a touchscreen computer.

### BRIEF DESCRIPTION OF THE DRAWINGS

The different figures show different embodiments. Specifically:

FIGS. 1A and 1B show keyboards on the tablet in different orientations of the tablet;

FIG. 2 shows organization of the keyboard on the tablet according to the users fingers;

FIG. 3 shows crowding of some of the keys in order to maintain the configuration of other keys;

FIG. 4 shows an adaptive overlay on the keyboard;

FIGS. 5 and 5B show the special shape for the housing that facilitates use of the keys.

### DETAILED DESCRIPTION

A tablet style computer may be a computer where 50% or more of one surface of the computer forms a display, and where commands can be entered on the display, e.g., by a touch screen, and where there is no integral user interface on the main housing. The present system may be used with a number of different kinds of computers, although preferably the system is used with a reduced-resource computer such as a tablet, laptop or PDA.

A touchscreen can be any screen that allows touching with fingers or other implements to enter and/or select data.

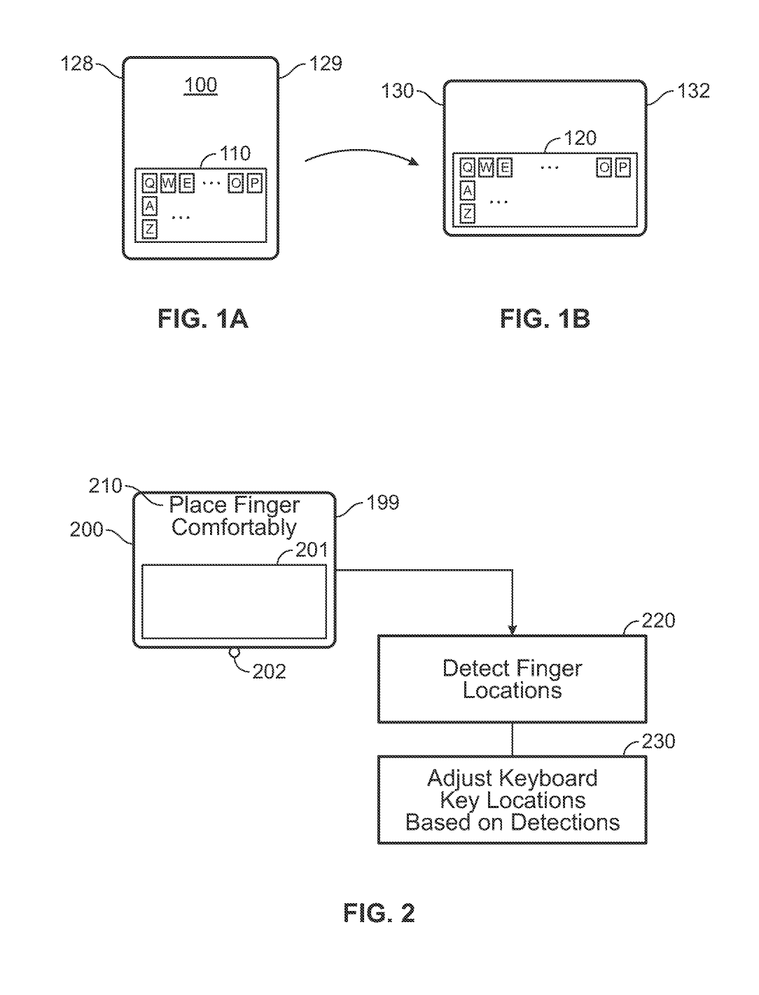

FIGS. 1A and 1B generically show a tablet computer in two orthogonal configurations in which it can be used. In FIG. 1A, the tablet computer 100 shows a keyboard 110. FIG. 1A shows the tablet computer being used in the so-called portrait configuration, where the width is narrower than the height.

The tablet computer can also be rotated by 90° into the landscape configuration shown in FIG. 1B. In this configuration, the keyboard 120 has a different size and shape, but may be in the same general configuration of area on the screen. In both of these situations, the keyboard includes the standard configuration of keys in the standard “QWERTY” configuration and format.

The tablet computer can include a processor 105 running a stored program which can be stored on a memory such as a solid-state memory 106. The processor can also be sensitive to information from external sensors including the touchscreen itself, and an accelerometer or other orientation sensor 107. The orientation sensor 107 can detect whether the device is in the portrait or landscape orientation. In operation, the program in the memory 106 can carry out many of the actions described herein.

When in the landscape position/configuration, there is physically more distance between the laterally facing walls of the computer 130, 132 then there is between the laterally facing walls 128, 129 in the portrait configuration. Therefore, the keyboard in the landscape configuration may occupy a larger area on the screen, or at least, can be wider.

When typing on the keyboard, a “power typist” often attempts to put their fingers on the keyboard and type as though it were a normal keyboard. However, often there is simply not enough room to produce a keyboard on the screen that can support a power typist. Embodiments of the present application address this issue.

Different people hold their fingers in different ways. This is the basic reason why not all keyboards are the same, and why some people like some keyboards better than others. According to an embodiment, in order to adapt the device to a user's preferences, a calibration technique is first carried out. FIG. 2 shows the computer 199 instructing the user to place their fingers comfortably on the screen in the position they want to use for typing at 210. The user then places their fingers as comfortably as they can be placed across the screen 200, e.g. in the keyboard area 201, or anywhere across the screen.

The user's fingers are detected at 220. This may use for example a camera 202 to detect the user's fingers near the screen and to image the locations of those fingers. If the user has been instructed to put all their fingers on the screen, then the touch sensitive display can detect the finger locations.

230 illustrates adjusting the keyboard key locations on the computer based on locations of the detecting fingers.

According to one embodiment, the user is allowed to manually change the locations of the keys or the spacing of the keys in order to make them more comfortable. For example, this may involve the user dragging the keys to another location.

In another embodiment, an auto calibration technique is carried out, where there are a number of different keyboard layouts, and based on the user's finger locations, the user's likely favorite keyboard layout is selected. This can be selected based on information that has been collected about different people and their postulated likes and dislikes of keyboards based on the way they keep their hands on the keyboard.

For example, in one embodiment, different people are tested or polled. The people are prompted to put their fingers on the keyboard or in the shape that they like to type on a touch sensitive screen. Those people are then told to determine what they like and don't like about keyboards. For example, there can be a number of different keyboard layouts such as 25 different keyboard layouts. Different users hold their hands in different ways. After testing the users' finger positions, each of these users is then asked which of the keyboard layouts they like the most, and what they like and don't like don't like about the different keyboard layouts. Based on this polling, the user's finger position may be mapped to a postulated favorite keyboard layout for other users having similar finger positions. Other users who hold their fingers in similar ways may be provided with a similar keyboard. In essence, therefore, this creates a database between user hand position and postulated favorite keyboard layout for that hand position. Then, the computer postulates a keyboard layout based on a user's hand position.

For example, different keyboards may have different amounts of space between the different letters, may have different size keys, may be ‘ergonomic’, that is some letters may be larger than other letters, or maybe some different layout.

The user can also request different keyboards, or request customization of the keyboard.

In one embodiment, if the user puts their fingers too far apart, the system can display a message saying “turn the device sideways or put your fingers closer together.”

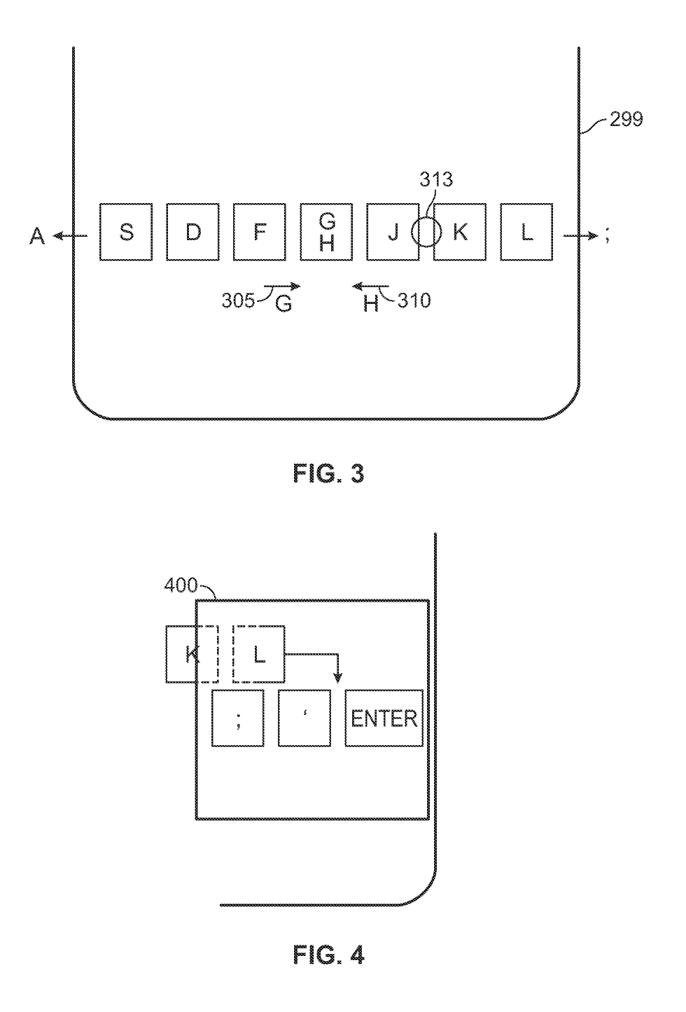

In another embodiment, an alternative keyboard layout can be used in which some parts of the keyboard are recycled. For example, FIG. 3 illustrates an embodiment where the G and H keys (and correspondingly other center keys such as (T, Y; B, N) use physically the same key. These keys which have two different possible functions (in the above embodiment G and H) are referred to herein as multi control areas or multi control keys. This compares with keys such as the F key in this embodiment that is a single control key.

The detection of which key is intended from the multi control keys can use an adaptive typing technique where the system automatically detects what letter is intended based on context of the letters that have been typed. This provides more total space from side to side of the keyboard, allowing larger letters and/or more space between keys. One problem from the adaptive typing technique, however, is that it makes it difficult for users to enter abbreviations, proper names, and other words that are not in the dictionary or which do not follow standard spelling rules, such as foreign words or abbreviations.

In another embodiment, however, the system detects the movement of the user's fingers e.g. using the camera or by using a capacitive technique to track the movement of the user's fingers or infra red movement detection. For example, the user's finger (for example on the left-hand) moving towards the right, in the direction of the arrow 305 towards the combined GH keys 300 is typed as a G. The user's finger moving towards the left, from the direction of arrow 310 towards the GH keys 300 enters an “H”. In this way, the user can touch type as usual, with their finger from their left-hand typing e.g. on the same key as the finger from the right-hand typing and H.

In a similar way, the keyboard may have detect movement of the user's fingers off the edge of the computer body 299, instead of leaving room on the keyboard for the extra keys such as: semicolon, quote and enter. The camera or capacitive sensor or infra red sensor or other sensor may track the movement the user's fingers. When a user's finger goes over the edge 299, the keyboard automatically adapts the keyboard screen, as shown in FIG. 4. In FIG. 4, the user's finger has gone over the edge 299. This brings up a new window 400 overlaid over the keyboard which shows the keys which are not normally shown, but which would be obtained based on the position that the user's finger was approaching. In this example, those keys can include the “;” key 402, the apostrophe key 404 and the enter key 406. By detecting the user's finger movement, the keyboard can be adaptively changed. Rather than making the keyboard longer, the keyboard is in essence stretched by popping up additional keys based on the movement of the user's finger.

In another embodiment, the additional keys can be selected based on the user's finger movement. For example, if there is only one key that is at the location over the edge 299 of the screen, that key would be automatically selected by the user's finger going over the edge of the screen.

The above shows stretching the keyboard in the side to side direction, but the same techniques can be used to stretch the keyboard in the up-and-down direction. For example, the user placing their finger in a position that would be above the top of the keyboard may bring up the numeric keypad.

The above embodiment has described a pop-up window that pops up to show additional keys that may be off the keyboard. In addition, however, a similar technique can be used to place a number of different keys on the same physical spot. For example, the quote and enter key can be the same key, and when the user moves their finger towards that key, it can bring up a pop-up window. More generally, however, the position of the users finger can be monitored, to postulate which of the keys on the pop up are likely to be intended to be selected.

The same pop-up technique can also be used when the user selects an area that is not squarely on either key, that is the areas between the keys can be considered as multi control areas that may represent multiple different selections.

In another embodiment, the camera or capacitive sensor monitors movement of the user's fingers to determine how far they move, for example if they move to the right of the “:” key by one keyboard length, this can postulate that the “quote” key is intended, if moving by two lengths, then the enter key can be postulated.

The same can be carried out for all finger positions including for the thumb.

According to another embodiment, the user finger locations are detected, and when the finger location is detected to be between two adjacent keys, the system uses an adaptive typing technique to postulate the letter that was meant, in context. This selects the postulated letter that was meant, rather than simply assuming that the user had put their finger in between two keys for choosing one of those two keys at random. As an example, say the user's finger is that the location 313, where it is in between two keys, touching one or both of those two keys, but not completely centered on either of those two keys. Rather than selecting one of the keys, this runs a routine whereby the key is adaptively selected based on either a spelling rule or a typing rule. The adaptively selected key(s) may also be displayed on the screen the postulated letter that was meant in a different color, or with some other indication that the key has been adaptively determined.

Another problem with typing on flat key surfaces such as a tablet is that there is no tactile sensation provided of the type that is usually provided by a keyboard. A real keyboard has real keys that actually move, have edges, and often make noises. The typist can feel the edges of the key, and know that their finger is properly located relative to the key.

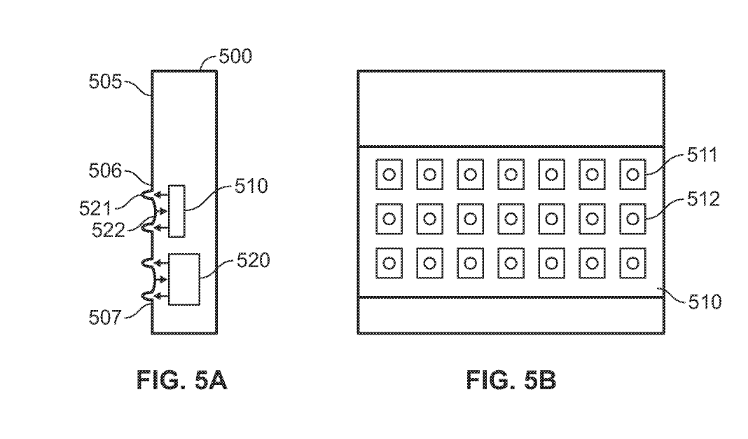

According to another embodiment, when in keyboard mode, the shape of the screen is somewhat deformed in the area of the keys. This can be done, for example, by using an electrically-controllable actuator such as a piezo electric actuator. FIG. 5A illustrates the computer 500 with its front screen 505, and a keyboard area between the areas 506, 507. In those areas, there are actuators 510, 520 that actually change the shape of the front of the screen. In an embodiment, those actuators may use piezoelectric material or piezoelectric actuation as shown in FIG. 5B. The array 510 includes a number of individual elements 511, 512 etc. Each of the elements can cause the front surface 505 of the screen to either extend by some small amount 521 and/or indent by some small amount 522. Both the extensions and the indentions can be by variable amounts. This can change the front shape of the screen to be similar in shape to the shape of a conventional key. This thereby produces an area of the front touch screen surface where the outer edges may be slightly raised and the lower edges may be slightly indented.

This front surface modification only occurs during the keyboard mode, and follows the keyboard.

In one embodiment, the adaptive keyboard can change the position of the keys, correspondingly changing the position of the indents and extrusions. This can facilitate the user using the keyboard, since the user will be able to feel the location of the different keys.

The above has described piezoelectric actuation; however it should be understood that this can also use any other kind of actuations that occur on the surface, such as magnetic, or fluid bladders, or any other way of changing the surface shape.

According to one embodiment, the shape of the surface may be changed for a fixed keyboard, any time the fixed keyboard is initiated.

According to another embodiment, the shape of the surface may be changed according to the adaptive keyboard described above.

Another embodiment may use bladders or other material to change the stiffness of the front keyboard surface to define the outlines of the different keys. For example, a bladder can be located under the front surface, that gets more inflated and less inflated to change the surface stiffness. Another embodiment can use electronically alterable stiffness material. As in the keyboard shape embodiment, this may be used for a fixed keyboard or for a variable keyboard.

Advantages may be obtained by using the adaptive keyboard described according to embodiments described herein. The changing of the shape of the surface according to the selected keyboard can change according to different configurations of keyboard. For example, a first keyboard configuration may have keys that extend 1 mm over the surface and 1 mm below the surface, while a second keyboard configuration can have keys that extend half a millimeter above and 1 mm below.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example other kinds of displays and/or computers can be controlled in a similar way. The above has described a touch screen being used to show the electronically configurable keyboard, however, other media for the electronically configurable keyboard can also be used.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

When operated on a computer, the computer may include a processor that operates to accept user commands, execute instructions and produce output based on those instructions. The processor is preferably connected to a communication bus. The communication bus may include a data channel for facilitating information transfer between storage and other peripheral components of the computer system. The communication bus further may provide a set of signals used for communication with the processor, including a data bus, address bus, and/or control bus.

The communication bus may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCl”) local bus, or any old or new standard promulgated by the Institute of Electrical and Electronics Engineers (“IEEE”) including IEEE 488 general-purpose interface bus (“GPIB”), and the like.

A computer system used according to the present application preferably includes a main memory and may also include a secondary memory. The main memory provides storage of instructions and data for programs executing on the processor. The main memory is typically semiconductor-based memory such as dynamic random access memory (“DRAM”) and/or static random access memory (“SRAM”). The secondary memory may optionally include a hard disk drive and/or a solid state memory and/or removable storage drive for example an external hard drive, thumb drive, a digital versatile disc (“DVD”) drive, etc.

At least one possible storage medium is preferably a computer readable medium having stored thereon computer executable code (i.e., software) and/or data thereon in a non-transitory form. The computer software or data stored on the removable storage medium is read into the computer system as electrical communication signals.

The computer system may also include a communication interface. The communication interface allows' software and data to be transferred between computer system and external devices (e.g. printers), networks, or information sources. For example, computer software or executable code may be transferred to the computer to allow the computer to carry out the functions and operations described herein. The computer system can be a network-connected server with a communication interface. The communication interface may be a wired network card, or a Wireless, e.g., Wifi network card.

Software and data transferred via the communication interface are generally in the form of electrical communication signals.

Computer executable code (i.e., computer programs or software) are stored in the memory and/or received via communication interface and executed as received. The code can be compiled code or interpreted code or website code, or any other kind of code.

A “computer readable medium” can be any media used to provide computer executable code (e.g., software and computer programs and website pages), e.g., hard drive, USB drive or other. The software, when executed by the processor, preferably causes the processor to perform the inventive features and functions previously described herein.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer, comprising:
an electronically configurable keyboard;
a processor, running a stored program, and receiving inputs from said keyboard; and
a memory, storing plural different keyboard layouts, and where said processor uses any of said keyboard layouts to configure said keyboard;
said program selecting one of said keyboard layouts by displaying instructions requesting a user to put their fingers in an area of said electronically configurable keyboard,
said processor detecting positions of the user's fingers on the area, and based on said positions, selecting one of said different keyboard layouts from said memory as a most likely keyboard layout to be preferred by said user based on said positions where the user has placed their fingers on the area.

2. The computer as in claim 1, wherein said memory also stores data representing a correlation between user finger positions, and likely ones of said different keyboard layouts to be selected for different user finger positions.

3. The computer as in claim 2, wherein said memory stores information that has been collected from actual people correlating which keyboard the people like, to the way they keep their hands on the area.

4. The computer as in claim 1, further comprising a touch sensitive display, wherein said configurable keyboard includes a keyboard displayed on the touch sensitive display, and any of said keyboard layouts can be displayed on said display.

5. The computer as in claim 4, wherein said processor detecting said positions by detecting positions using the touch sensitive display.

6. The computer as in claim 1, further comprising a camera, and wherein said processor detecting said positions by detecting positions using the camera to detect pictures of fingers.

7. The computer as in claim 1, wherein the at least one of said keyboard layouts includes multiple single control keys that each represent only a single selection, and at least multiple multi control keys that each represent multiple different selections, where said multi control keys are each used for selecting multiple different letters and/or characters.

8. The computer as in claim 7, wherein said processor determines which of said multiple different letters and/or characters is intended from selecting one of said multi control keys, using an adaptive technique that determines in context which of the multiple different letters or characters was intended.

9. The computer as in claim 7, wherein movement of the users finger is monitored, and wherein said processor determines which of said multiple different letters and/or characters is intended from selecting one of said multi control keys, by following said movement of a user's finger, selecting a character based on which of the two fingers goes towards the multi control key.

10. The computer as in claim 1, wherein at least one of said keyboard layouts includes an area outside the area which represents selection of at least one key.

11. The computer as in claim 7, wherein said processor pops-up additional keys when the user selects one of the multi control keys.

12. A computer, comprising:
an electronically configurable keyboard
a processor, running a stored program, and receiving inputs from said keyboard;
said electronically configurable keyboard which has multiple single control areas that each represent only a single selection, and at least multiple multi control areas that each represent multiple different selections,
said processor detecting a selection of one of said multi control areas,
said processor detecting movement of a user's finger when selecting said one of said multi control areas,
and selecting one of said multiple different selections when selecting said multi control areas based on a direction of movement of the user's finger.

13. The computer as in claim 12, wherein said inputs from said keyboard are inputs on a touchscreen.

14. The computer as in claim 12, wherein said multi control areas are keys of the keyboard which represent multiple different selections from a single key.

15. The computer as in claim 12, wherein said multi control areas are areas on said keyboard between two keys of the keyboard.

16. A computer, comprising:
an electronically configurable keyboard
a processor, running a stored program, and receiving inputs from said keyboard;
said electronically configurable keyboard which has multiple single areas that each represent a single selection, and at least multiple multi control areas that each represent multiple different selections,
said processor detecting a selection of one of said multi control areas, and in response to detecting selection of said one of said multi control areas, popping up a display of an area showing multiple different selections representing the different selections available from the multi control area.

17. The computer as in claim 16, wherein said processor tracks movement of the users finger, and postulates which of the multiple selections are intended by selection of a multi control area based on the movement of the users finger.

18. The computer as in claim 16, wherein said multi control areas are keys of the keyboard which represent multiple different selections from a single key.

19. The computer as in claim 16, wherein said multi control areas are areas on said keyboard between two keys of the keyboard.
